(19) United States
(12) Patent Application Publication
(10) Pub. No.: US 2014/0285352 A1
(43) Pub. Date: Sep. 25, 2014

(54) PORTABLE DEVICE AND VISUAL SENSATION DETECTING ALARM CONTROL METHOD THEREOF

(71) Applicant: LG ELECTRONICS INC., Seoul (KR)

(72) Inventors: Eunhyung CHO, Seoul (KR); Sinae CHUN, Seoul (KR); Jihwan KIM, Seoul (KR)

(73) Assignee: LG ELECTRONICS INC., Seoul (KR)

(21) Appl. No.: 14/019,048

(22) Filed: Sep. 5, 2013

Related U.S. Application Data
(60) Provisional application No. 61/803,773, filed on Mar. 20, 2013.

(30) Foreign Application Priority Data
Jul. 16, 2013 (KR) 10-2013-0083257

(51) Int. Cl. G08B 7/06

(52) U.S. Cl. CPC G08B 7/06
USPC 340/691.5

(57) ABSTRACT

A portable device and a visual sensation detecting alarm control method thereof are disclosed. The portable device includes a display unit to display visual information including a visual alarm interface, a gaze detection unit to acquire a front image of the portable device, a vibration motor unit to generate a tactile feedback, a sound unit to generate an acoustic alarm, and a controller to control the display unit, the gaze detection unit, the vibration motor unit, and the sound unit. In a case in which an event necessary to provide notification is generated, the controller determines whether a user gazes at the portable device using the acquired image.

This application claims the benefit of U.S. Provisional Application No. 61/803,773, filed on Mar. 20, 2013, and Korean Patent Application No. 10-2013-0083257, filed on Jul. 16, 2013, which is hereby incorporated by reference as if fully set forth herein.

### BACKGROUND OF THE INVENTION

1. Field of the Invention

The present invention relates to a portable device and a visual sensation detecting alarm control method thereof and, more particularly, to a portable device that is capable of deactivating a tactile feedback or an acoustic alarm based on determination as to whether a user gazes at the portable device and maintaining deactivation of the tactile feedback or the acoustic alarm even in a case in which the user does not gaze at the portable device and a visual sensation detecting alarm control method thereof.

2. Discussion of the Related Art

With development of various portable devices, such as a mobile phone, a tablet personal computer (PC), a watch phone, and a head mounted display (HMD), technologies for user convenience have attracted considerable attention. In particular, various technologies based on sensation, such as tactile sensation, of a user have been developed in order to maximize user convenience.

In recent years, technologies for controlling operation of a portable device based on various kinds of sensation, such as visual sensation and auditory sensation, of a user have also attracted considerable attention in addition to the above-mentioned technologies using tactile sensation of the user. In a case in which the portable device is controlled using various kinds of sensation of the user, it is possible to provide a more friendly user interface.

Particularly in case of a technology based on visual sensation, it is possible to efficiently control the portable device even when the user cannot control the portable device using hands, thereby maximizing user convenience.

In a case in which an event necessary to provide notification is generated, most portable devices may transmit notification to a user using at least one selected from among a tactile feedback including a vibration alarm, an acoustic alarm, and a visual alarm.

When the tactile feedback, the acoustic alarm, and the visual alarm are generated, the user may recognize corresponding notification through tactile sensation, auditory sensation, and visual sensation.

The tactile feedback, the acoustic alarm, and the visual alarm are recognized by different sensory organs of the user. In order to increase a notification transmission rate, therefore, the portable device may simultaneously or sequentially execute two or more alarms.

In a case in which a tactile feedback or an acoustic alarm is generated even after the user recognizes a visual alarm using visual sensation, the user may feel inconvenienced in using the portable device. In a case in which the user uses the portable device in a public place, the user may disturb other persons around the user if a tactile feedback and an acoustic alarm recognized through auditory sensation and tactile sensation are generated.

That is, in a case in which the portable device generates two or more alarms to transmit notification to the user, the alarms may be generated regardless of whether the user has recognized the notification or conditions of a surrounding environment.

### SUMMARY OF THE INVENTION

Accordingly, the present invention is directed to a portable device and a visual sensation detecting alarm control method thereof that substantially obviate one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a portable device deactivates tactile feedback or an acoustic alarm based on determination as to whether a user gazes at the portable device and maintains deactivation of the tactile feedback or the acoustic alarm even in a case in which the user does not gaze at the portable device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view showing an alarm operation of a portable device according to an embodiment of the present invention;

FIG. 2 is a block diagram of the portable device according to the embodiment of the present invention;

FIG. 3 is a view showing a smart notification mode operation of the portable device according to the embodiment of the present invention;

FIG. 4 is a view showing a smart notification mode operation of a portable device according to another embodiment of the present invention;

FIG. 5 is a view showing a smart notification mode operation of a portable device according to a further embodiment of the present invention;

FIG. 6 is a flowchart showing a method of performing a smart notification mode operation of the portable device according to an embodiment of the present invention; and

FIG. 7 is a flowchart showing a method of performing a smart notification mode operation of the portable device according to another embodiment of the present invention.

### DETAILED DESCRIPTION OF THE INVENTION

Reference will now be made in detail to the preferred embodiments of the present invention, examples of which are illustrated in the accompanying drawings.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

In a case in which an event necessary to provide notification is generated, a portable device may transmit notification to a user using at least one selected from among a tactile feedback, an acoustic alarm, and a visual alarm as previously described.

FIG. 1 is a view showing an alarm operation of a portable device according to an embodiment of the present invention.

Specifically, FIG. 1-(a) shows a case in which a portable device transmits notification to a user using a tactile feedback, FIG. 1-(b) shows a case in which a portable device transmits notification to a user using an acoustic alarm, and FIG. 1-(c) shows a case in which a portable device transmits notification to a user using a visual alarm.

In a case in which a portable device transmits notification to a user using a tactile feedback as shown in FIG. 1-(a), the user may recognize the tactile feedback using tactile sensation. According to an embodiment of the present invention, the tactile feedback may include a vibration alarm. In addition, the user may recognize a sound generated due to vibration of the portable device or another object contacting the portable device using auditory sensation to recognize the tactile feedback.

In a case in which a portable device transmits notification to a user using an acoustic alarm as shown in FIG. 1-(b), the user may recognize the acoustic alarm using auditory sensation.

In a case in which a portable device transmits notification to a user using a visual alarm as shown in FIG. 1-(c), the portable device may display a visual alarm interface corresponding to the visual alarm and the user may recognize the displayed visual alarm interface using visual sensation. As can be seen from the above description, the tactile feedback, the acoustic alarm, and the visual alarm are recognized by different sensory organs of the user. In order to increase a notification transmission rate, therefore, the portable device may simultaneously or sequentially execute two or more alarms.

In a case in which a tactile feedback or an acoustic alarm is generated even after the user recognizes a visual alarm using visual sensation, the user may feel inconvenienced in using the portable device. In a case in which the user uses the portable device in a public place, the user may disturb other persons around the user if a tactile feedback and an acoustic alarm recognized through auditory sensation and tactile sensation are generated.

That is, in a case in which the portable device generates two or more alarms to transmit notification to the user, the alarms may be generated regardless of whether the user has recognized the notification or conditions of a surrounding environment.

Therefore, the present invention proposes a portable device that is capable of determining whether a user has recognized notification based on visual sensation of the user and deactivating a tactile feedback or an acoustic alarm without additional user setting and a visual sensation detecting alarm control method thereof. In the present invention, the visual sensation detecting alarm control method of the portable device is referred to as a smart notification mode, which may be changed according to designer's intention.

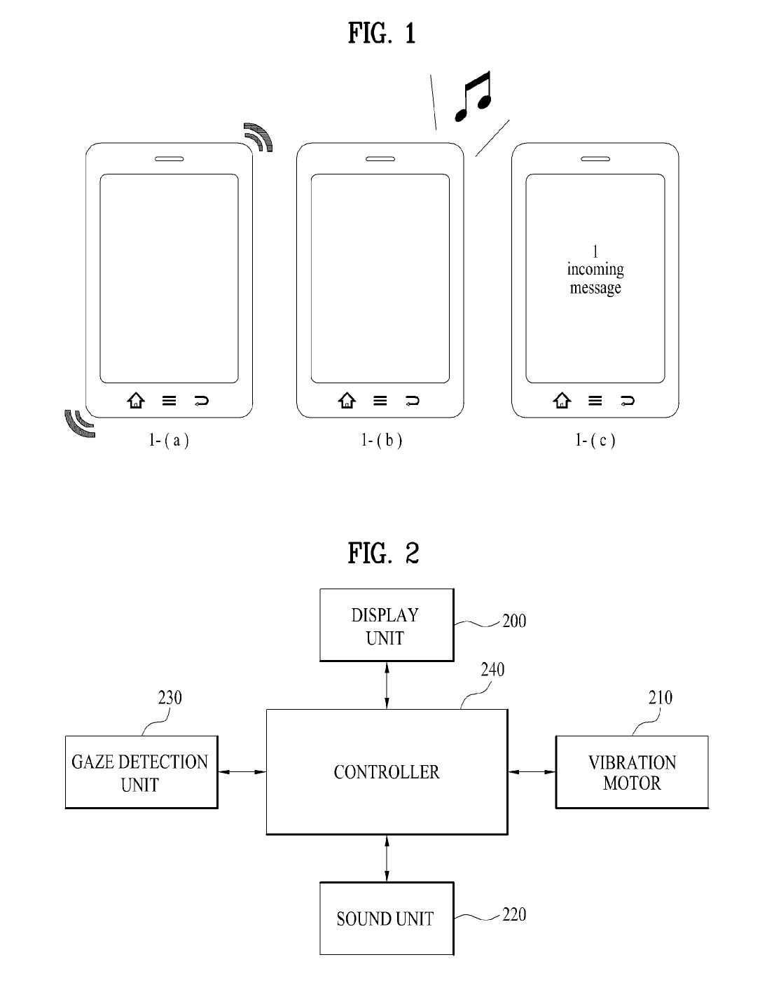

FIG. 2 is a block diagram of the portable device according to the embodiment of the present invention.

The portable device according to the embodiment of the present invention may include a display unit 200, a vibration motor 210, a sound unit 220, a gaze detection unit 230, and a controller 240. Hereinafter, the respective components of the portable device will be described in detail.

The display unit 200 may display visual information including a visual alarm interface. The display unit 200 may allow user touch and may display a visual alarm interface corresponding to a visual alarm activated according to operation of the controller 240 for a predetermined period of time. When the activated visual alarm is deactivated, the display unit 200 may display an indicator indicating deactivation of the visual alarm under control of the controller 240. When the user touches the displayed indicator, the display unit 200 may display information of the visual alarm. The information of the visual alarm may include information regarding activation time of the visual alarm, which may be changed according to designer's intention.

The vibration motor 210 may generate a tactile feedback according to operation of the controller 240. The sound unit 220 may generate an acoustic alarm according to operation of the controller 240. The tactile feedback and the acoustic alarm may be activated under control of the controller 240 or according to user input of setting or may be automatically activated according to generation of an event without control of the controller 240 or user input of setting, which may be changed according to designer's intention.

The gaze detection unit 230 may acquire a front image of the portable device. The gaze detection unit 230 may periodically acquire the front image of the portable device at predetermined time intervals. The gaze detection unit 230 may operate automatically or under control of the controller 240. The time intervals set to acquire the front image of the portable device may be changed according to user setting, which may be changed according to designer's intention.

In a case in which an event necessary to provide notification is generated, the controller 240 may determine whether the user gazes at the portable device using the image acquired by the gaze detection unit 230.

Specifically, the controller 240 may detect eyes of the user or a face of the user from the acquired image to determine whether the user gazes at the portable device. In order to determine whether the user gazes at the portable device, the controller 240 may detect pupils of the user or eye blinking of the user as well as the eyes and the face of the user, which may be changed according to designer's intention. Furthermore, the controller 240 may periodically detect the eyes of the user or the face of the user at predetermined time intervals.

In addition, the controller 240 may determine whether the user gazes at the portable device for a predetermined period of time using the detection results. Specifically, in a case in which the user gazes at the portable device for a period of time shorter than the predetermined period of time, the controller 240 may determine that the user does not gaze at the portable device. On the other hand, in a case in which the user gazes at the portable device for a period of time longer than the predetermined period of time, the controller 240 may determine that the user gazes at the portable device.

Upon determining that the user gazes at the portable device, in a case in which a tactile feedback or an acoustic alarm activated according to an event is present, the controller 240 may deactivate the activated tactile feedback or acoustic alarm and activate a visual alarm related to the event. The controller 240 may be set to activate a tactile feedback or an acoustic alarm when an event is generated.

Upon determining that the user does not gaze at the portable device, on the other hand, the controller 240 may maintain an activated state of a tactile feedback or an acoustic alarm activated according to an event. In a case in which a tactile feedback or an acoustic alarm is not activated, the controller 240 may activate a tactile feedback or an acoustic alarm according to an event.

Upon determining that the user gazes at the portable device after a tactile feedback or an acoustic alarm is activated, the controller may deactivate the activated tactile feedback or acoustic alarm and activate a visual alarm related to the event as described above.

Even after the visual alarm is activated, the controller 240 may determine whether the user gazes at the portable device, i.e. whether the user recognizes the visual alarm interface displayed on the display unit, using the image detected by the gaze detection unit 230.

In this case, the controller 240 may maintain a deactivated state of the tactile feedback or the acoustic alarm regardless of a user's gaze. The visual alarm activated as described above may be deactivated according to user touch or a predetermined timer. In a case in which the visual alarm is deactivated according to the predetermined timer, the controller 240 may activate an indicator indicating deactivation of the visual alarm.

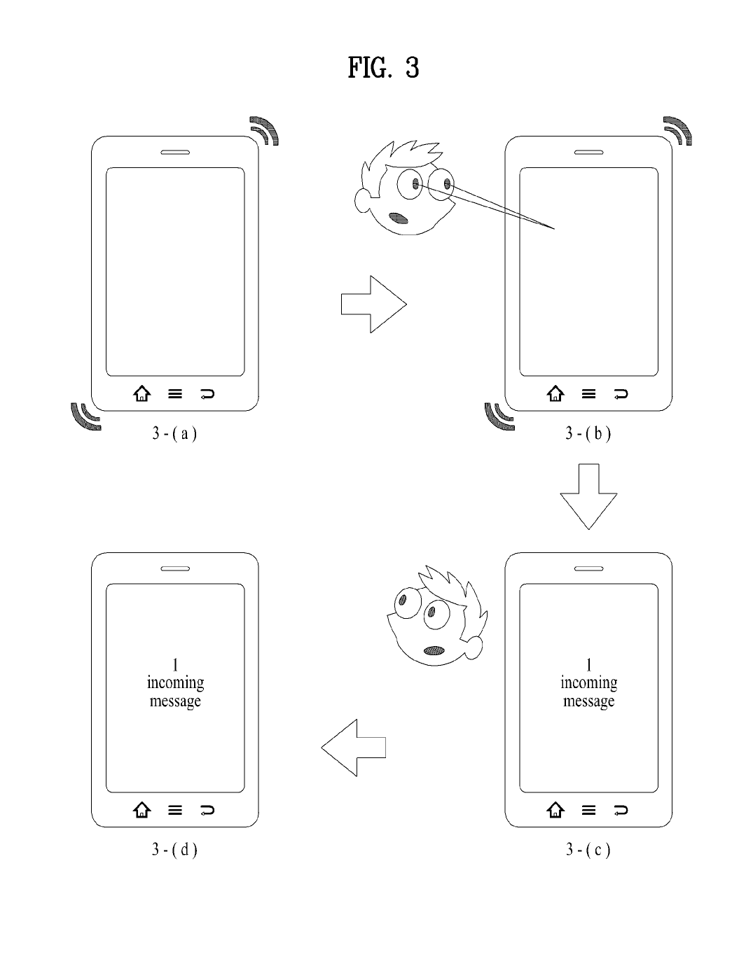

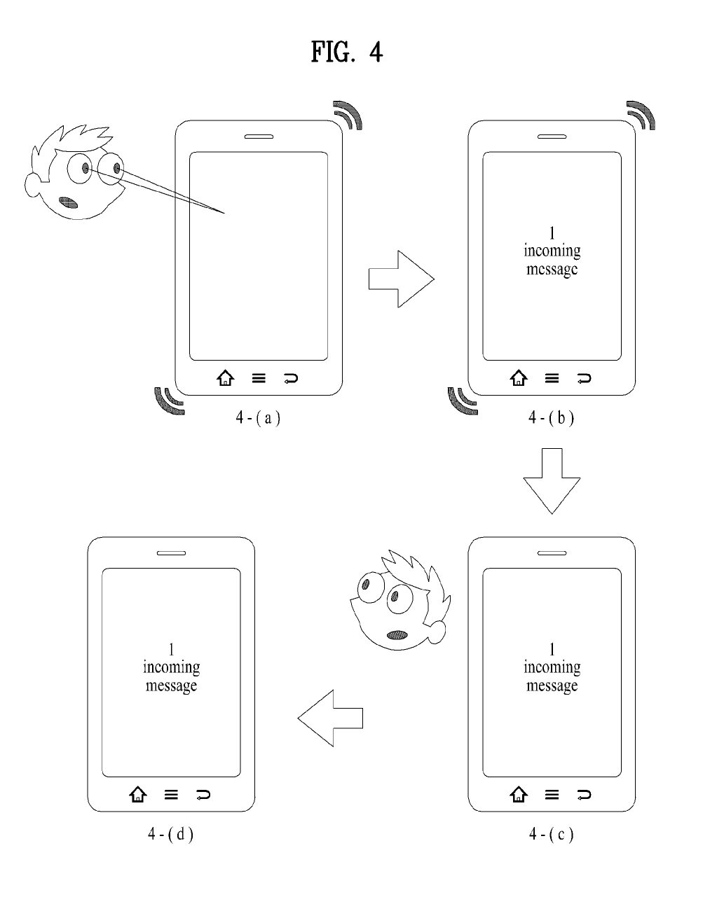

FIG. 3 is a view showing a smart notification mode operation of the portable device according to the embodiment of the present invention.

FIG. 3 shows a case in which, when an event necessary to provide notification is generated, a tactile feedback or an acoustic alarm related to the event is automatically activated. As previously described with reference to FIG. 2, a tactile feedback or an acoustic alarm may be activated whenever an event is generated under control of the controller or according to user setting.

In a case in which an event necessary to provide notification is generated, as shown in FIG. 3-(a), the portable device may activate a tactile feedback or an acoustic alarm according to setting. A user may recognize activation of the tactile feedback using tactile sensation or auditory sensation. Alternatively, the user may recognize activation of the acoustic alarm using auditory sensation. As shown in FIG. 3-(b), the portable device may determine whether the user gazes at the portable device. Specifically, as previously described with reference to FIG. 2, the gaze detection unit of the portable device may periodically acquire a front image of the portable device at predetermined time intervals. The controller of the portable device may determine whether the user gazes at the portable device using the image acquired by the gaze detection unit. In this case, the controller may periodically detect eyes, pupils, eye blinking, or a face of the user from the image acquired by the gaze detection unit at predetermined time intervals.

Upon determining that the user gazes at the portable device, the controller may deactivate the tactile feedback or the acoustic alarm activated according to the event and may activate a visual alarm.

As shown in FIG. 3-(c), the controller may determine whether the user gazes at the portable device using the image detected by the gaze detection unit even after the visual alarm is activated. Even upon determining that the user does not gaze at the portable device any longer, as shown in FIG. 3-(c), the controller may maintain an activated state of the visual alarm.

As shown in FIG. 3-(d), the controller may maintain the activated visual alarm and a deactivated state of the tactile feedback or the acoustic alarm.

In the portable device according to the embodiment of the present invention, therefore, a deactivated state of the tactile feedback or the acoustic alarm related to the event confirmed by the user is maintained, whereby it is possible to avoid inconvenience of a user having to deactivate the tactile feedback or the acoustic alarm.

FIG. 4 is a view showing a smart notification mode operation of a portable device according to another embodiment of the present invention.

FIG. 4 is similar to FIG. 3 except that FIG. 4 shows a case in which, when an event is generated, a tactile feedback or an acoustic alarm related to the event is not activated. As previously described with reference to FIG. 2, a tactile feedback or an acoustic alarm may be activated whenever an event is generated under control of the controller or according to user setting.

In a case in which an event necessary to provide notification is generated, as shown in FIG. 4-(a), the portable device may determine whether the user gazes at the portable device. Specifically, as previously described with reference to FIG. 2, the gaze detection unit of the portable device may periodically acquire a front image of the portable device at predetermined time intervals. The controller of the portable device may determine whether the user gazes at the portable device using the image acquired by the gaze detection unit. In this case, the controller may periodically detect eyes, pupils, eye blinking, or a face of the user from the image acquired by the gaze detection unit at predetermined time intervals. In addition, the controller may maintain a deactivated state of a tactile feedback or an acoustic alarm.

As shown in FIG. 4-(b), the portable device may activate a visual alarm. In this case, the controller may determine whether the user gazes at the portable device using the image detected by the gaze detection unit even after the visual alarm is activated.

Even upon determining that the user does not gaze at the portable device any longer, as shown in FIG. 4-(c), the controller may maintain an activated state of the visual alarm.

As shown in FIG. 4-(d), the controller may maintain the activated visual alarm and a deactivated state of the tactile feedback or the acoustic alarm.

That is, the portable device may determine whether the user gazes at the portable device when an event necessary to provide notification is generated and may activate the visual alarm while maintaining a deactivated state of the tactile feedback or the acoustic alarm to immediately transmit the notification to the user. Consequently, it is not necessary for the user to deactivate the tactile feedback or the acoustic alarm, thereby improving user convenience.

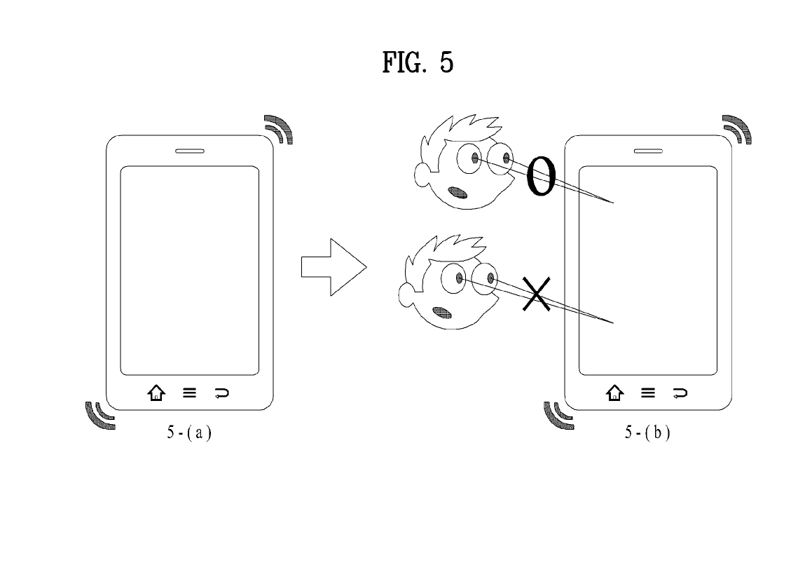

FIG. 5 is a view showing a smart notification mode operation of a portable device according to a further embodiment of the present invention.

FIG. 5 is similar to FIG. 3 or FIG. 4 except that FIG. 5 shows a smart notification mode operation of a portable device in a case in which plural users gaze at the portable device.

The portable device may be generally used for individual use. For this reason, it is necessary to control operation of the portable device based on specific intention of a specific user having the portable device in possession. In a case in which an alarm is processed according to gaze of a person other than the owner of the portable device at the smart notification mode operation described with reference to FIGS. 3 and 4, however, notification may not be provided to the owner of the portable device who should receive the notification. In this embodiment, therefore, a smart notification mode operation of the portable device to provide notification according to plural users' gaze is performed.

In a case in which an event necessary to provide notification is generated, as shown in FIG. 5-(a), the portable device may activate a tactile feedback or an acoustic alarm according to setting. A user may recognize activation of the tactile feedback using tactile sensation or auditory sensation. Alternatively, the user may recognize activation of the acoustic alarm using auditory sensation.

FIG. 5-(b) shows operation of the portable device in a case in which plural users simultaneously or sequentially gaze at the portable device.

Even in a case in which the plural users gaze at the portable device, the gaze detection unit may acquire a front image of the portable device as previously described with reference to FIGS. 3 and 4. The controller may detect only eyes or a face of a specific user having the portable device in possession from the image acquired by the gaze detection unit. The gaze detection unit may acquire image data regarding eyes or a face of a specific user having the portable device in possession and the controller may store the acquired image according to user setting. A storage sequence or method may be changed according to designer's intention.

Consequently, the controller may detect eyes or a face of a specific user using the stored image data regarding the eyes or the face of the specific user. Specifically, the controller may compare eyes or faces of plural users contained in the image acquired by the gaze detection unit with eyes or a face of a predetermined specific user to determine whether the eyes or the face of one of the plural users correspond to the eyes or the face of the predetermined specific user. Upon determining that the eyes or the face of one of the plural users correspond to the eyes or the face of the predetermined specific user, the controller may determine whether the specific user gazes at the portable device using the detected eyes or face of the specific user.

FIG. 5-(b) shows a process of processing only gaze of a user determined as the owner of the portable device. A method of determining whether a specific user gazes at the portable device is identical to the method described with reference to FIGS. 2 to 4 and, therefore, a detailed description thereof will be omitted. The operation of the portable device after it is determined that the specific user gazes at the portable device is identical to that of the portable device described with reference to FIGS. 2 to 4 and, therefore, a detailed description thereof will be omitted.

In this embodiment, therefore, the portable device provides an alarm according to intention of a specific user having the portable device in possession, thereby maximizing user convenience.

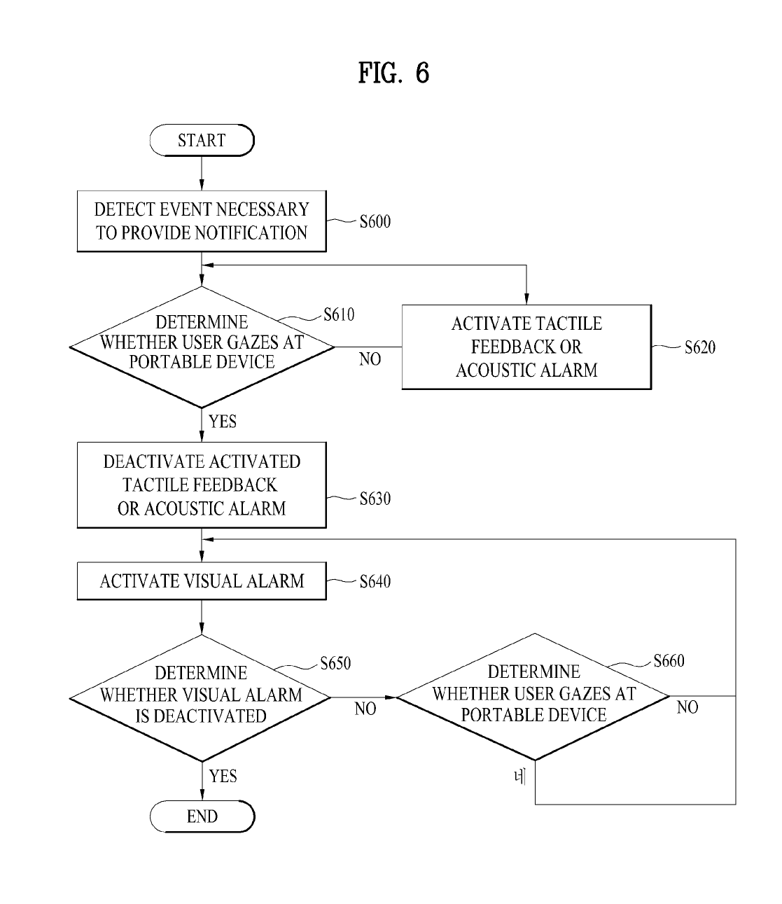

FIG. 6 is a flowchart showing a method of performing the smart notification mode operation of the portable device according to an embodiment of the present invention.

In a case in which an event necessary to provide notification is generated, the portable device may detect the event (S600). Specifically, the controller may detect the event.

Subsequently, the portable device may determine whether a user gazes at the portable device (S610). As previously described with reference to FIGS. 2 to 5, the controller may determine whether the user gazes at the portable device using an image acquired by the gaze detection unit. A concrete determination method is identical to the determination method described with reference to FIGS. 2 to 5.

Upon determining that the user does not gaze at the portable device, the controller may activate a tactile feedback or an acoustic alarm (S620). As previously described, the tactile feedback and the acoustic alarm may be activated under control of the controller or according to user input of setting or may be automatically activated according to generation of an event without control of the controller or user input of setting, which may be changed according to designer's intention.

Upon determining that the user gazes at the portable device, the controller may deactivate the tactile feedback or the acoustic alarm activated according to the event (S630).

In addition, the controller may activate a visual alarm (S640). In this case, the controller may maintain a deactivated state of the tactile feedback or the acoustic alarm.

The controller may determine whether the visual alarm is deactivated (S650). The visual alarm activated as described above may be deactivated according to user touch or a predetermined timer. In a case in which the visual alarm is deactivated according to the predetermined timer, the controller may activate an indicator indicating deactivation of the visual alarm.

Upon determining that the visual alarm is deactivated, the controller may end the smart notification mode operation.

Upon determining that the visual alarm is not deactivated, on the other hand, the controller may determine whether the user gazes at the portable device (S660). In this case, the controller may maintain an activated state of the visual alarm regardless of a user's gaze. In addition, the controller may maintain the deactivated state of the tactile feedback or the acoustic alarm.

For an event which the user has confirmed once using visual sensation, the portable device maintains a deactivated state of a tactile feedback or an acoustic alarm through the above operation even when the user does not gaze at the portable device such that notification is not provided any longer. Consequently, it is possible to avoid inconvenience of a user having to deactivate the tactile feedback or the acoustic alarm.

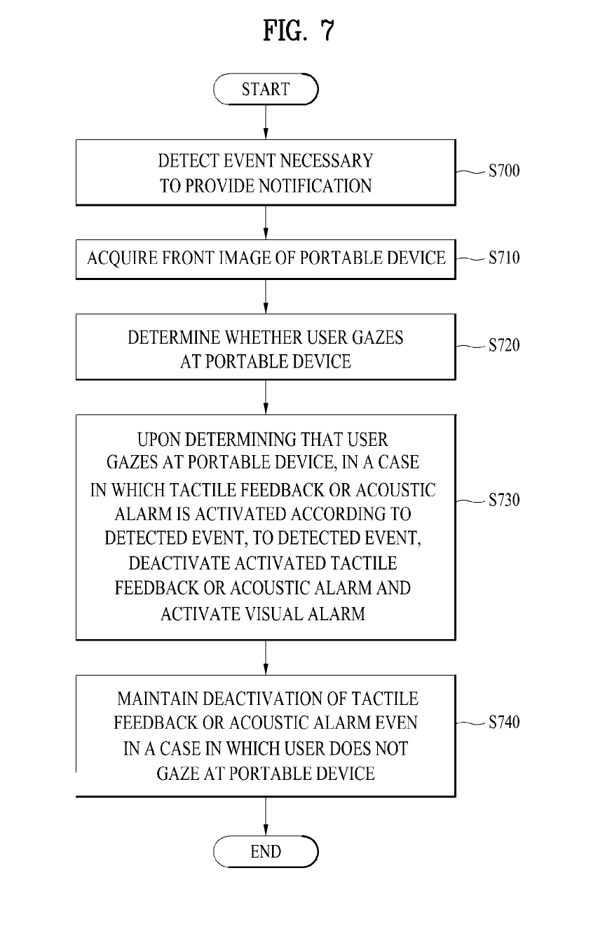

FIG. 7 is a flowchart showing a method of performing a smart notification mode operation of the portable device according to another embodiment of the present invention.

In a case in which an event necessary to provide notification is generated, the portable device may detect the event (S700). Specifically, the controller may detect the event.

Subsequently, the gaze detection unit may acquire a front image of the portable device (S710). As previously described with reference to FIGS. 2 to 5, the gaze detection unit may periodically acquire the front image of the portable device at predetermined time intervals. The gaze detection unit may operate automatically or under control of the controller. The time intervals set to acquire the front image of the portable device may be changed according to user setting, which may be changed according to designer's intention.

Even in a case in which plural users gaze at the portable device, the gaze detection unit may acquire a front image of the portable device.

Subsequently, the controller may determine whether the user gazes at the portable device (S720). Specifically, as previously described with reference to FIGS. 2 to 5, the controller may detect eyes of the user or a face of the user from the image acquired by the gaze detection unit to determine whether the user gazes at the portable device. In order to determine whether the user gazes at the portable device, the controller may detect pupils of the user or eye blinking of the user as well as the eyes and the face of the user, which may be changed according to designer's intention. Furthermore, the controller may periodically detect the eyes of the user or the face of the user at predetermined time intervals.

In addition, the controller may determine whether the user gazes at the portable device for a predetermined period of time using the detection results. Specifically, in a case in which the user gazes at the portable device for a period of time shorter than the predetermined period of time, the controller may determine that the user does not gaze at the portable device. On the other hand, in a case in which the user gazes at the portable device for a period of time longer than the predetermined period of time, the controller may determine that the user gazes at the portable device.

In a case in which the plural users gaze at the portable device, the controller may detect only eyes or a face of a specific user having the portable device in possession from the image acquired by the gaze detection unit. The gaze detection unit may acquire image data regarding eyes or a face of a specific user having the portable device in possession and the controller may store the acquired image according to user setting. A storage sequence or method may be changed according to designer's intention.

Consequently, the controller may detect eyes or a face of a specific user using the stored image data regarding the eyes or the face of the specific user. Specifically, the controller may compare eyes or faces of plural users contained in the image acquired by the gaze detection unit with eyes or a face of a predetermined specific user to determine whether the eyes or the face of one of the plural users correspond to the eyes or the face of the predetermined specific user. Upon determining that the eyes or the face of one of the plural users correspond to the eyes or the face of the predetermined specific user, the controller may determine whether the specific user gazes at the portable device using the detected eyes or face of the specific user.

Upon determining that the user gazes at the portable device, when a tactile feedback or an acoustic alarm is activated according to the detected event, the controller may deactivate the activated tactile feedback or acoustic alarm and activate a visual alarm (S730).

Subsequently, the controller may maintain a deactivated state of the tactile feedback or the acoustic alarm even in a case in which the user does not gaze at the portable device (S740). That is, as previously described with reference to FIGS. 2 to 5, the controller may determine whether the user gazes at the portable device, i.e. whether the user recognizes the visual alarm interface displayed on the display unit, using the image detected by the gaze detection unit even after the visual alarm is activated.

In addition, the controller may activate a visual alarm while maintaining the deactivated state of the tactile feedback or the acoustic alarm regardless of a user's gaze. As previously described with reference to FIGS. 2 to 5, the visual alarm activated as described above may be deactivated according to user touch or a predetermined timer. In a case in which the visual alarm is deactivated according to the predetermined timer, the controller may activate an indicator indicating deactivation of the visual alarm. When the user touches the display indicator, the display unit may display information of the visual alarm. The information of the visual alarm may include information regarding activation time of the visual alarm, which may be changed according to designer's intention.

As is apparent from the above description, according to the present invention, it is possible to control operation of the portable device according to user's intention and conditions of a surrounding environment, thereby maximizing user convenience.

According to the present invention, it is possible to control operation of the portable device according to various kinds of user input, thereby providing a more friendly user interface.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A portable device comprising:
a display unit configured to display visual information comprising a visual alarm;
a gaze detection unit configured to acquire an image in front of the portable device;
a vibration motor unit configured to generate a tactile feedback;
a sound unit configured to generate an acoustic alarm; and
a controller configured to control the display unit, the gaze detection unit, the vibration motor unit, and the sound unit,
wherein the controller is further configured to:
when an event necessary to provide notification is generated in the portable device,
activate the tactile feedback or the acoustic alarm according to the event,
determine whether a user gazes at the portable device using the acquired image,
when the user gazes at the portable device, deactivate the tactile feedback or the acoustic alarm which is already activated according to the event and activate a visual alarm according to the same event which activated the tactile feedback or the acoustic alarm, and
even when the user does not gaze at the portable device after the visual alarm is activated and the user is notified by the visual alarm, maintain deactivation of the tactile feedback or the acoustic alarm and maintain activation of the visual alarm.

2. The portable device according to claim 1, wherein the controller maintains deactivation of the tactile feedback or the acoustic alarm for only the event necessary to provide the notification and, when a new event necessary to provide notification is generated, the controller re-activates the deactivated tactile feedback according to the new event.

3. The portable device according to claim 1, wherein the controller sets activation of the tactile feedback or the acoustic alarm.

4. The portable device according to claim 3, wherein the activated visual alarm is deactivated according to a user touch or a predetermined timer.

5. The portable device according to claim 4, wherein, when the activated visual alarm is deactivated according to the predetermined timer, the controller activates an indicator indicating deactivation of the visual alarm.

6. The portable device according to claim 5, wherein, when the user touches the activated indicator, the display unit displays information of the visual alarm.

7. The portable device according to claim 1, wherein, after the visual alarm is activated, the controller re-determines whether the user gazes at the portable device using the acquired image.

8. The portable device according to claim 7, wherein, in determining whether the user gazes at the portable device using the acquired image, the controller detects eyes or a face of the user from the acquired image to determine whether the user gazes at the portable device.

9. The portable device according to claim 8, wherein the controller periodically detects the eyes or the face of the user at predetermined time intervals.

10. The portable device according to claim 9, wherein the controller determines whether the user gazes at the portable device for a predetermined period of time using the detection results.

11. The portable device according to claim 10, wherein, when the user gazes at the portable device for a period of time shorter than the predetermined period of time, the controller determines that the user does not gaze at the portable device.

12. The portable device according to claim 10, wherein, when the user gazes at the portable device for a period of time longer than the predetermined period of time, the controller determines that the user gazes at the portable device.

13. The portable device according to claim 8, wherein, when a plurality of users simultaneously or sequentially gaze at the portable device, the controller detects only eyes or a face of a predetermined specific user from the acquired image.

14. The portable device according to claim 13, wherein the controller compares eyes or faces of the plurality of users contained in the acquired image with the eyes or the face of the predetermined specific user to determine whether the eyes or the face of one of the plurality of users correspond to the eyes or the face of the predetermined specific user.

15. The portable device according to claim 14, wherein the controller determines whether the specific user gazes at the portable device for a predetermined period of time to determine whether the specific user gazes at the portable device.

16. The portable device according to claim 1, wherein the portable device comprises any one selected from among a mobile phone, a tablet personal computer (PC), a watch phone, and a head mounted display (HMD).

17. A visual sensation detecting alarm control method of a portable device comprising:
detecting an event necessary to provide notification;
activating the tactile feedback or the acoustic alarm according to the event;
acquiring an image in front of the portable device;
determining whether a user gazes at the portable device using the acquired image;
when the user gazes at the portable device, deactivating the tactile feedback or acoustic alarm which is already activated according to the event and activating a visual alarm according to the same event which activated the tactile feedback or the acoustic alarm; and
maintaining deactivation of the tactile feedback or the acoustic alarm and maintaining activation of the visual alarm even when the user does not gaze at the portable device after the visual alarm is activated and the user is notified by the visual alarm.

18. The visual sensation detecting alarm control method according to claim 17, further comprising setting activation of the tactile feedback or the acoustic alarm.

19. The visual sensation detecting alarm control method according to claim 17, wherein the portable device comprises any one selected from among a mobile phone, a tablet PC, a watch phone, and an HMD.

20. The visual sensation detecting alarm control method according to claim 17, wherein the step of determining whether the user gazes at the portable device using the acquired image comprises:
periodically detecting eyes or a face of the user from the acquired image at predetermined time intervals; and
determining whether the user gazes at the portable device for a predetermined period of time using the detection results comprising:
determining that the user does not gaze at the portable device when the user gazes at the portable device for a period of time shorter than the predetermined period of time; and
determining that the user gazes at the portable device when the user gazes at the portable device for a period of time longer than the predetermined period of time.
